(19) United States
(12) Patent Application Publication
(10) Pub. No.: US 2002/0105619 A1
(43) Pub. Date: Aug. 8, 2002

(54) On color management system of liquid crystal-display projector

(76) Inventor: Chi-Hsiung Lin, Taoyan (TW)

Correspondence Address: BIRCH STEWART KOLASCH & BIRCH, PO BOX 747, FALLS CHURCH, VA, 22040-0747, US

(21) Appl. No.: 09/809,322

(22) Filed: Mar. 16, 2001

(30) Foreign Application Priority Data
Feb. 8, 2001 (TW) 090202033

(51) Int. Cl. G02F 1/1335; G03B 21/14

(52) U.S. Cl. 353/20; 353/31; 349/9

(57) ABSTRACT

A beam-split system of an LCD projector for improving the contract effect receives light from the light source of the LCD projecting apparatus and signal of an image to be projected, and outputs images to be projected. The beam-split system includes a plurality of polarizing filters, a plurality of polarization beam splitters (PBS), and three sets of LCD panels. The polarizing filters are for transferring a polarization state of a specific color beam. The PBSs are disposed on the light-path where the polarizing filter located, and each of PBSs includes a pair of prisms for splitting various colors of the polarization light beam that is incident into the PBS. The LCD panels are to reflect respectively the above-mentioned polarization light beams having three different colors, and in the meantime, change their polarization state. At least a filter, out of the three sets of LCD panels, for filtering the color of light beam transmitting into the LCD panel is provided on the incident surface. With the filter, in case each of the single color of light beam mixes with the dispersive stray light of other colors, this dispersive stray light of other colors, when passing through the LCD panel, is absorbed or reflected by the filter provided in front of the LCD panel. Therefore, the purity of color in the incident light beam can be maintained and the luminosity of the dispersive stray light in the beam-split system is greatly reduced, as a result, the color purity and the contrast effect of the output image is improved.

### FIELD OF THE INVENTION

The invention relates to an improvement for a beam-split system of a liquid crystal display (LCD) projecting apparatus, and in particular, relates to a beam-split system having a specific filtering design to eliminate the dispersive stray light beam in the beam-split system.

### BACKGROUND OF THE INVENTION

Reflective liquid crystal (LCD) display projector is a popular product whose major optical mechanism includes an optical beam-split system. As far as the beam-split system of the reflective LCD projector is concerned, it is composed of the optical devices such as a polarizing light beam splitter (PBS) and a reflective twisted nematic LCD panel etc., and in association with an off-axis or an on-axis light-path design. Among them, although the light-path design for the on-axis is advantageous in the design and manufacturing, it's hard to attain high contrast effect.

FIG. 1 is a cross-sectional view of light-path principle of the beam-split system according to a prior art. The beam-split system includes four sets of PBS and reflective LCD panels with three original colors—red, blue and green, and employs the on-axis light-path path design. As shown in FIG. 1, the beam-split system 10 includes four sets of PBS 11, 12, 13 & 14, four sets of polarizing filter 15, 16, 17 & 18, a green reflective LCD panel 20, a blue reflective LCD panel 21, a red reflective LCD panel 22, and a polarizer 19. Each of PBS includes two sets of prisms, that is, the PBS 11 includes prisms 111 & 112, the PBS 12 includes prisms 121 & 122, the PBS 13 includes prisms 131 & 132, and the PBS 14 includes prisms 141 & 142.

The light source 1 of the beam-split system 10 generates polarizing light beam 2 in S-polarization state. The polarizing light beam 2 which is reflected by the three LCD panels 20, 21 & 22 receives the signal of an image to be projected, therefore, the beam leaving the beam-split system projects an image, which is represented by the signal, to be projected.

Polarizing filters 15, 16, 17 & 18 being formed by phase retarders can filter a specific color of polarizing light beam. The polarizing filters 15 & 18 can make the red & blue beams passing through them keep in the same polarization state while make the green beam passing through them transform from S-state of polarization to P state. However, the polarizing filters 16 & 17 can make the blue beam passing through them keep in the same polarization state while make the red beam passing through them transform from S-state of polarization to P-state.

As shown in FIG. 1, while the polarization beam reaches the interface of the color-split lens 111 & 112, the red-blue beam (R/B beam) 2a being in s-state is reflected and transmitted toward the polarizing filter 16. And the green beam component 2b being in P-state transmits through prisms 112 and enters into the PBS 12.

The green beam component 2b, after transmitting through the interface of the prisms 121 & 122 and being reflected by the LCD panel 20, transforms from P-state into green-beam 3b in S-state. The green beam 3b, after continuing to transmit through the PBS 14 and being reflected by the interface of the prisms 141 & 142, then transmits through polarizing filter 18. In this way, the green beam 3b can transform from S-state to P-state, and finally pass through the polarizer 19, thereby, form green beam component 4b (G-beam component) of the projecting image.

In the same manner, the polarizing filter 16 can divide the R/B beam 2a into blue beam 21a in S-state and red beam 21b transforming from S-state to P-state. The red beam 21b, after transmitting through the interface of the prisms 131 & 132 and being reflected by the red LCD panel 22, transforms into red beam 2b in S-state. The red beam 2b, after continuing to transmit through the polarizing filter 17, transforms from S-state into P-state, after that, transmits through polarizer 19 and forms a red beam component 23b of projecting image.

In addition, blue-beam 21a, after being reflected respectively by the interface of the prisms 131 & 132 and the blue LCD panel 121, transfers into blue beam 22a in P-state entering into the PBS 14. Subsequently, it keeps on transmitting through the polarizing filter 17, the prisms 141 & 142, the polarizing filter 18 and the polarizer 19, finally becomes a blue beam 23a of projecting image.

Consequently, the three P-state beams of the red, blue and green beam components 23b, 23a & 4b are combined to become the projecting image of the LCD projector.

However, as a matter of fact, the prism that constitutes the polarizing beam splitter (PBS) oftentimes is not an ideal one because of its surface coating film, as a result, its extinction ratio is relatively low. That is, the ratio of the transmittance rate of the P-state light beam and the transmittance rate of the S-state light beam through the interface of the two-color prism of the PBS is relatively low. In other word, the P-state green light beam component 2b transmitting through the interface of prism 111 and 112 still mixes with a small amount of S-state R/B (red/blue) light beam component. This dispersive stray light beam, through the polarization and reflection of the green LCD panel 20, finally results in that the green beam light component 4b for forming image also mixes with a portion of R/B light beam component, thereby, affects the contrast effect of the projecting image. Similarly, the S-state R/B light beam component 2a also mixes with a small amount of P-state green light component. Again, this dispersive stray light beam, through the reflection of the blue LCD panel 21 or the red LCD panel 22, finally becomes a portion of the output blue light beam component 23a or red light beam component 23b, thereby, affects the color purity and contrast effect of the projecting image.

In the same way, similar to the above-mentioned reflective type of LCD projector, same dispersive stray light beam problems also occur in the transmissive type of LCD panel, thereby, the color purity and contrast ratio of its projecting image are greatly affected.

### SUMMARY OF THE INVENTION

An object of the invention is to provide a beam-split system of an LCD projecting apparatus having a preferred contract effect. The beam-split system receives light from the light source of the LCD projecting apparatus and signal of an image to be projected, as well as outputs images to be projected. The beam-split system includes a plurality of polarization filters, a plurality of polarization beam splitters (PBS), and three sets of LCD panels. The polarizing filters are for transforming a polarization state of a specific color beam. The PBS is disposed on the light-path where the polarizing filter located, and each of PBS includes a pair of prisms for splitting the incident colorful polarizing light beam through the PBS. The LCD panels are to reflect respectively the above-mentioned polarizing light beams having three different colors and in the meantime, transform their polarization state.

The characteristics of the beam-split system are as follows:

At least a LCD panel has its incident surface provided with a filter for filtering the color of light beam transmitting into the LCD panel. In this way, in case that each of the single color of light beam mixes with dispersive stray light of some other colors, this dispersive stray light can be absorbed or reflected by the filter provided in front of the LCD panel while passing through the LCD panel. Consequently, the color purity transmitting into each of the LCD panels can be maintained, and the dispersive stray light luminance of the output light beam in the beam-split system can be greatly diminished. As a result, the color purity and the contrast effect of the output image of the beam-split system can be greatly enhanced.

### BRIEF DSCRIPTION OF TH DRAWING

FIG. 1 is a cross-sectional view of the light-path principle for a beam-split system according to a prior art.

FIG. 2 is a cross-sectional view illustrating the light path in the beam-split system of a reflective LCD projecting apparatus of the first embodiment according to the invention.

FIG. 3 is a cross-sectional view illustrating the light path in the beam-split system of a transmissive LCD projecting apparatus of the second embodiment according to the invention.

### DETAIL DESCRIPTION OF THE PRFERRED EMBODIMENTS

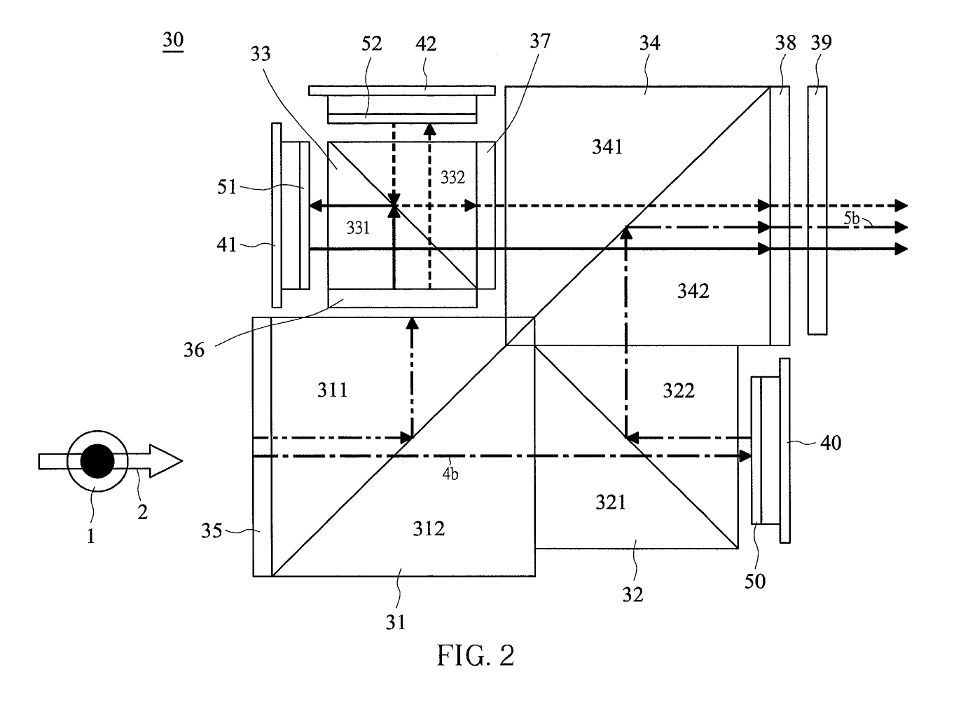

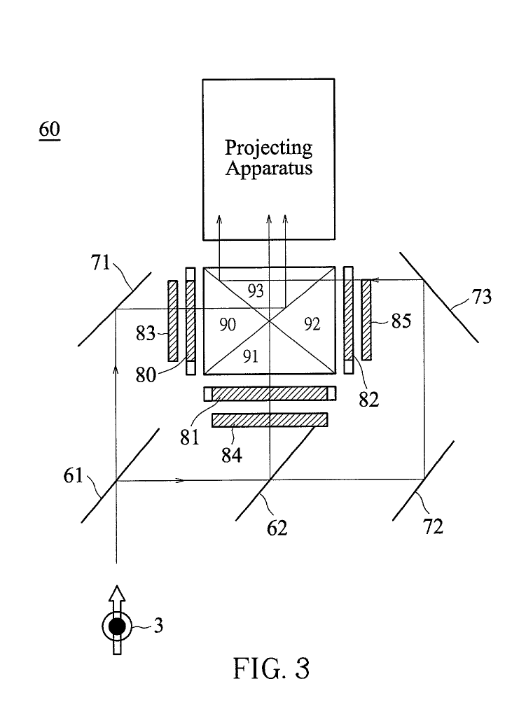

FIG. 2 is a cross-sectional view illustrating the light path in the beam-split system of a reflective LCD projecting apparatus of the first embodiment according to the invention. FIG. 3 is a cross-sectional view illustrating the light path in the beam-split system of a transmissive LCD projecting apparatus of the second embodiment according to the invention.

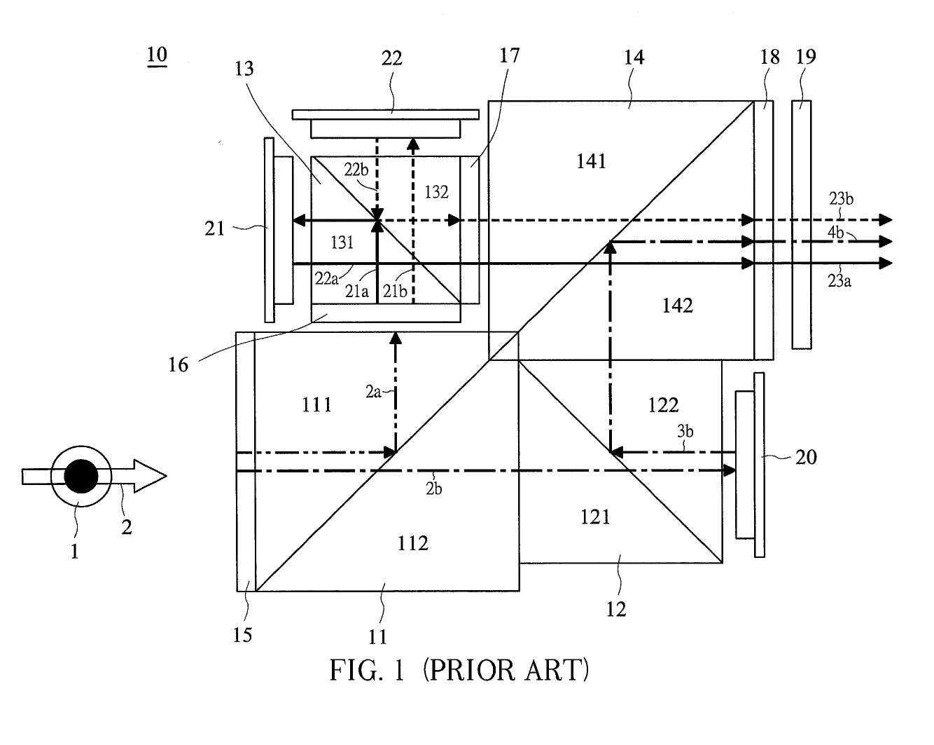

As shown in FIG. 2, according to the first embodiment of the invention, a beam-split system 30 includes four sets of PBS 31, 32, 33 & 34, four sets of polarizing filter 35, 36, 37 & 38. The beam-split system 30 also includes a green reflective LCD panel 40, a blue reflective LCD panel 41, a red reflective LCD panel 42, and a polarizer 39. Among them, each of the LCD panels is a reflective twisted Nematic LCD panel, and each of the PBS includes a dichroic prism. That is, PBS 31 includes prism 311 and 312, PBS 32 includes prism 321 and 322, PBS 33 includes prism 331 and 332, while PBS 34 includes prism 341 and 342. The light path design and the operating principle of the system is similar to the technical content as depicted in the illustration of FIG. 1.

As shown in FIG. 2, the characteristics of the beam-split system 30 are as follows:

Each of the light beam incident surface of the three sets of LCD panels 40, 41, and 42 is provided respectively with filters 50, 51, and 52 for filtering the light beam color transmitting into each of the LCD panels. Each of the filters 50, 51, and 52 can be a filtering piece or a coating film, having light beam filtering effect, that is coated on the surface of the liquid crystal. Moreover, each of the filter is of an absorbing-type that can absorb a specific color of light beam, or of a reflective-type that can reflect a specific color of light beam. For instance, filter 50 that is provided on the incident light beam surface of the green light beam LCD panel 40 is a filtering piece or a coating film which can absorb RIB (red and blue) light beam. The filter 50 can also be a reflective filtering piece or a coating film that can reflect R/B light beam. The same is true for blue LCD panel 41 and red LCD panel 42.

By employing the above-mentioned filters provided at the light beam incident surface of the LCD panels, any dispersive stray lights mixed in a specific color of light beam can be absorbed or reflected by their corresponding filter. For instance, the R/B dispersive stray lights mixed in the green light beam is absorbed or reflected by the filter 50 before transmitting into the green LCD panel 40. Therefore, the illuminance of the R/B light beam in the final obtained green light beam component 5b can be diminished to a minimum amount. Similarly, filter 51 can filter the G/R (green/red) dispersive stray light transmitting into the LCD panel 41, and filter 52 can filter the B/G (blue/green) dispersive stray light transmitting into the LCD panel 42. As a result, since the final obtained various colors of output light beam possesses minimum amount of stray color light beam, the color purity and the contrast ratio of the projected image can be greatly improved.

As shown in FIG. 3, according to the second embodiment of the invention, a beam-split system 60 of a transmissive type of LCD projecting apparatus includes two sets of dichroic device 61 and 62, three sets of reflective mirrors 71, 72, and 73. The beam-split system 60 also includes a transmissive type of red LCD panel 80, a transmissive type of green LCD panel 81, and a transmissive type of blue LCD panel 82. The beam-split system 60 further includes a red filter 83, a green filter 84, a blue filter 85, as well as a set of prism combination composed of prisms 91, 92, 93, and 94. Among them, all the above-mentioned LCD panels are transmissive twisted nematic LCD panels, and each incident surface of light beam of the dichroic devices can be a prism of a dichroic mirror. Besides, each prism is the one that has its surface coated with a dichroic coating film in order to reflect or transmit the different colors of the incident polarized light beam. The light paths of various colors in the beam-split system 60 are the same as the ones shown in FIG. 2.

The red filter 83 is a filtering piece or a coating film that can absorb or reflect G/B light, and the green filter 84 is a filtering piece or a coating film that can absorb or reflect R/B light. Also, the blue filter 85 is a filtering piece or a coating film that can absorb or reflect R/G light.

As refer again to FIG. 3, a white light source 3 of the incident beam-split system 60, through the light beam splitting of a dichroic device 61, is split into a red light beam and a G/B light beam. The red light beam, reflecting from the reflecting mirror 71, continues to transmit toward the LCD panel 80. The G/B light beam, through the light beam splitting of a dichroic device 62, is split into a green light beam and a blue light beam. Subsequently, the green light beam transmits toward the LCD panel 81 while the blue light beam, through the reflection of the reflecting mirrors 72 and 73, transmits toward the LCD panel 82. The light beams, transmitting through the LCD panels, can have their specific polarizing state in accordance with their polarization characteristics. Finally, the three light beams, transmitting through each of the LCD panels, are subjected to the reflection and transmission of the combination of the beam-splitting prisms in accordance with the their polarization states and colors. Consequently, the three light beams are combined into an output light beam of the beam-split system 60.

However, since the material itself employed by the dichroic device is not a perfect one, the beam-splitting effect oftentimes is incomplete. Therefore, various colors of light beams more or less have dispersive stray light beams mixed up with. As a result, the color purity and contrast effect of the output image are greatly affected because of the impurity of various colors of light beams in the beam-split system.

The characteristic of the embodiment is as follows: on the incident surface of the light beam of each of the LCD panels is provided respectively with filters 83, 84, and 85. Therefore, if the light beams transmitting through each of the LCD panels mixes with dispersive stray lights, these dispersive stray lights are absorbed or reflected by the filters 83, 84, and 85 before transmitting into the LCD panel 80, 81 ,and 82. For instance, a red light beam split by the dichroic device 61 still mixes up with a small amount of dispersive stray lights in green and blue colors. These dispersive stray lights are absorbed or reflected by the filters 83 before transmitting into the LCD panel 80. Therefore, the purity of the red light beam incident to the LCD panel 80 is thus greatly improved. Similarly, the green light filter 84 and the blue light filter 85 possess the similar effect.

Therefore, the key point of the invention is to provide reflective type or transmissive type of light beam filters that can sufficiently filter each of the dispersive stray lights transmitting through them. Therefore, the color purity of the output light beam in the beam-split system can be greatly enhanced, thereby, the color purity and the contrast effect of the projecting image are greatly improved.

While the invention has been described by way of example and in terms of a preferred embodiment, it is to be understood that the invention is not limited to the disclosed embodiment. On the contrary, it is intended to cover various modifications. Therefore, the scope of the appended claims should be accorded the broadest interpretation so as to encompass all such modifications.

What is claimed is:

1. A beam-split system of a liquid crystal display (LCD) projecting apparatus receiving light beam from the light source of the LCD projecting apparatus and signal of an image to be projected, as well as outputing image to be projected comprising:
a plurality of polarizing filter for transferring a polarization state of a specific color beam;
a plurality of polarizing light beam splitter (PBS) disposed on the light-path where the polarizing filter located, and each PBS includes a pair of prisms for splitting the incident colorful polarizing light beam through the PBS; and
three sets of LCD panels to reflect respectively the above-mentioned polarizing light beams having three different colors and in the meantime, transform their polarization state;
wherein the characteristic of the beam-split system is as follows: at least a LCD panel has its incident surface provided with a filter for filtering the color of light beam transmitting into the LCD panel.

2. The beam-split system of a LCD projecting apparatus of claim 1, wherein the filter is either a reflective type filter or an absorbing type of filter.

3. The beam-split system of a LCD projecting apparatus of claim 1, wherein the filter is a coating film having the effect of filtering light beam.

4. The beam-split system of an LCD projecting apparatus of claim 1, wherein the output light beam of the beam-split system is a S-state polarizing light beam.

5. The beam-split system of an LCD projecting apparatus of claim 1, wherein the output light beam of the beam-split system is a P-state polarizing light beam.

6. The beam-split system of an LCD projecting apparatus of claim 1, wherein the beam-split system divides the incident light beam into three basic color light beams, and further makes the three basic color light beams transmitting into the three sets of LCD panels for forming images.

7. The beam-split system of a LCD projecting apparatus of claim 1, wherein each of the polarizing filters is a combination of phase retarder.

8. The beam-split system of a LCD projecting apparatus of claim 1, wherein the beam-split system is provided with four sets of polarizing filters, among them, two sets of them can transform one of the basic color's polarization state, another two sets can transform another one of the three basic color's polarization state.

9. The beam-split system of an LCD projecting apparatus of claim 1, wherein the LCD panel is a reflective twisted nematic LCD panel.

10. The beam-split system of an LCD projecting apparatus of claim 1, wherein a light beam polarizer is further provided at the end of the light path to enhance the contract effect of the projected images generated by the beam-split system.

11. A beam-split system of a liquid crystal display (LCD) projecting apparatus receiving light beam from the light source of the LCD projecting apparatus and signal of an image to be projected, as well as outputing image to be projected comprising:
a plurality of dichroic device, for dividing the light beam from the light source into 3 light beams with different colors;
a plurality of mirror, for reflecting the light beam in different colors;
three sets of LCD panels, for receiving and transmitting the light beams with the 3 different colors reflected respectively by the dichroic device or mirror; and
a beam-split prism set, further comprising a plurality of dichroic devices for reflecting and transmitting the various colors of light beams transmitting through the LCD panel;
wherein the characteristic of the beam-split system is as follows: at least the incident surface side of a LCD panel is provided with a filter or a polarizer filter for filtering color of the light beam incident into the LCD panel.

12. The beam-split system of a LCD projecting apparatus of claim 11, wherein the filter is either a reflective type filter or an absorbing type of filter.

13. The beam-split system of a LCD projecting apparatus of claim 11, wherein the dichroic device has an incident surface, of a light beam, is a prism of a dichroic mirror.

14. The beam-split system of a LCD projecting apparatus of claim 11, wherein the beam-split prism set further comprises 4 dichroic devices.

15. The beam-split system of a LCD projecting apparatus of claim 14, wherein the dichroic device has an incident surface, of a light beam, is a prism of a dichroic mirror.

16. The beam-split system of an LCD projecting apparatus of claim 11, wherein the beam-split system further comprises 2 sets of dichroic devices for dividing the light beam from the light source into three basic color light beams, and further makes the three basic color light beams transmitting into the three sets of LCD panels for forming images.

17. The beam-split system of an LCD projecting apparatus of claim 11, wherein the LCD panel is a transmissive twisted nematic LCD panel.
